(19) United States
(12) Patent Application Publication
(10) Pub. No.: US 2009/0052036 A1
(43) Pub. Date: Feb. 26, 2009

(54) PRISM SHEET AND LIQUID CRYSTAL DISPLAY DEVICE USING THE SAME

(75) Inventor: SHAO-HAN CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/949,056

(22) Filed: Dec. 3, 2007

(30) Foreign Application Priority Data
Aug. 20, 2007 (CN) 200710201409.X

(51) Int. Cl. G02B 5/124

(52) U.S. Cl. 359/530

(57) ABSTRACT

An exemplary prism sheet according to a preferred embodiment includes a light input surface, a light output surface and a plurality of triangular pyramidal optical elements. The light output surface is opposite to the light input surface. The plurality of triangular pyramidal optical elements are formed at the light output surface. A bottom surface of each triangular pyramidal optical element is coplanar with the light output surface. Each triangular pyramidal optical element has three sides. Each one of the three sides of each triangular pyramidal optical element is connected with a side of adjacent triangular pyramidal optical element. A liquid crystal display device using the prism sheet is also provided.

### CROSS-REFERENCE TO RELATED APPLICATIONS

This application is related to five co-pending U.S. patent applications, which are: applications Ser. No. 11/933,439 and Ser. No. 11/933,441, filed on Nov. 1, 2007, and both entitled “PRISM SHEET AND LIQUID CRYSTAL DISPLAY DEVICE USING THE SAME”, application Ser. No. 11/946,860 and Ser. No. 11/946,862, filed on Nov. 29, 2007, and both entitled “PRISM SHEET AND LIQUID CRYSTAL DISPLAY DEVICE USING THE SAME”, and application serial no. [to be determined], with Attorney Docket No. USI 5565, and entitled “PRISM SHEET AND BACKLIGHT MODULE USING THE SAME”. In all these co-pending applications, the inventor is Shao-Han Chang. All of the co-pending applications have the same assignee as the present application. The disclosures of the above identified applications are incorporated herein by reference.

### BACKGROUND OF THE INVENTION

1. Field of the Invention

The present invention relates to prisms, and particularly, to a prism sheet used in a backlight module.

2. Discussion of the Related Art

FIG. 5 represents a typical liquid crystal display device 100. The liquid crystal display device 100 includes a housing 11 and a plurality of lamps 12 for emitting light are above a base of the housing 11. The liquid crystal display device 100 further includes a light diffusion plate 13, a prism sheet 10, and a liquid crystal display panel 15 stacked on the housing 11 in that order. An interior of the housing 11 is configured for reflecting light towards the light diffusion plate 13. The light diffusion plate 13 includes a plurality of dispersion particles (not shown). The dispersion particles are configured for scattering light, and thereby enhancing the uniformity of received light emitting from the light diffusion plate 13.

Referring to FIG. 6, the prism sheet 10 includes a base layer 101 and a prism layer 102 formed on the base layer 101. The prism layer 102 has a plurality of V-shaped protrusion 103. Each V-shaped protrusion 103 extends along a direction parallel to one edge of the prism sheet 10. The V-shaped protrusions 102 are regularly and periodically arranged parallel to each other. Typically, a method of manufacturing the prism sheet 10 includes following steps. First, an melted ultraviolet-cured transparent resin is coated on the base layer 101. Second, the melted ultraviolet-cured transparent resin is solidified to form the prism layer 102.

In use, unscattered light emitted from the lamps 12 enters the prism sheet 10 after being scattered in the diffusion plate 13. The light is refracted by the V-shaped protrusions 103 of the prism sheet 10 and is thereby concentrated, so that a brightness of light illumination is increased. Finally, the light propagates into an LCD panel 15 disposed above the prism sheet 10.

However, the light may create moire pattern interference on the LCD panel 15 due to the V-shaped structures 102 being aligned similarly to the LCD pixels. In order to decrease the moire pattern interference, the liquid crystal display device 100 needs to add an upper light diffusion film 14 between the prism sheet 10 and the LCD panel 15. Although the upper light diffusion film 14 and the prism sheet 10 are in contact with each other, a plurality of air pockets still exists at the boundaries therebetween. When the liquid crystal display device 100 is in use, light passes through the air pockets, and some of the light undergoes total reflection at one or another of the corresponding boundaries. In addition, an amount of light is absorbed by the upper light diffusion film 14. As a result, a light brightness of the liquid crystal display device 100 is reduced.

What is needed, therefore, is a new prism sheet and a liquid crystal display device using the prism sheet that can overcome the above-mentioned shortcomings.

### SUMMARY

A prism sheet according to a preferred embodiment includes a light input surface, a light output surface and a plurality of triangular pyramidal optical elements. The light output surface is opposite to the light input surface. The plurality of triangular pyramidal optical elements are formed at the light output surface. A bottom surface of each triangular pyramidal optical element is coplanar with the light output surface. Each triangular pyramidal optical element has three sides. Each one of the three sides of each triangular pyramidal optical element is connected with a side of adjacent triangular pyramidal optical element.

A liquid crystal display device according to a preferred embodiment includes a light source, a light diffusion plate, a prism sheet and a liquid crystal display panel. The light diffusion plate is disposed above the light source. The same prism sheet as described in the previous paragraph is employed in this embodiment. The prism sheet is disposed above the light diffusion plate. The liquid crystal display panel is disposed above the prism sheet.

Other advantages and novel features will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating principles of the present prism sheet and liquid crystal display device. Moreover, in the drawings, like reference numerals designate corresponding parts throughout several views, and all the views are schematic.

FIG. 1 is an exploded, side cross-sectional view of a liquid crystal display device according to a first embodiment of the present invention.

FIG. 2 is an isometric view of a prism sheet of the liquid crystal display device of FIG. 1.

FIG. 3 is a top plan view of the prism sheet of FIG. 2.

FIG. 4 is a top plan view of a prism sheet according to a second embodiment of the present invention.

FIG. 5 is an exploded, side cross-sectional view of a conventional liquid crystal display device.

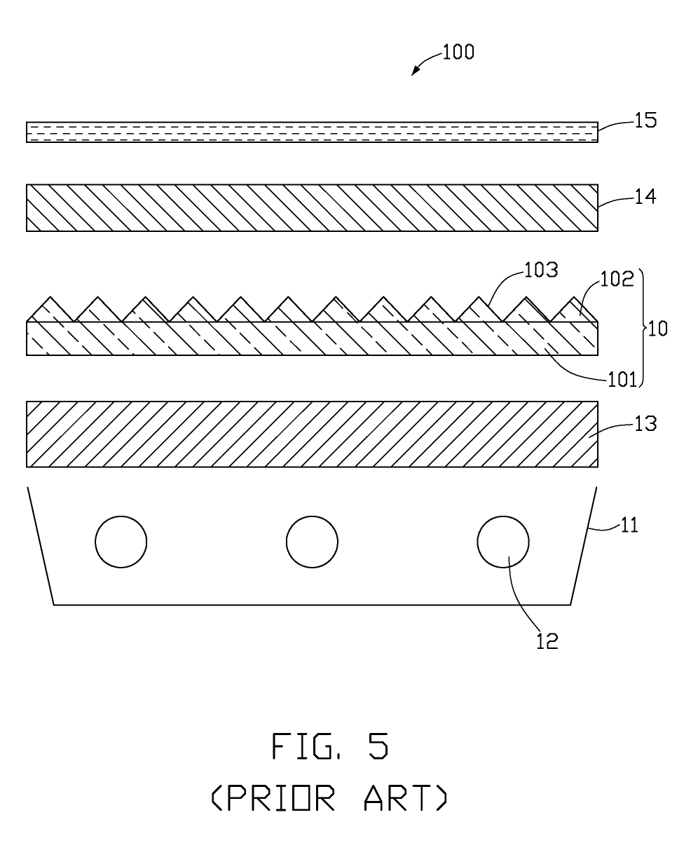

FIG. 6 is an isometric view of a prism sheet of the liquid crystal display device of FIG. 5.

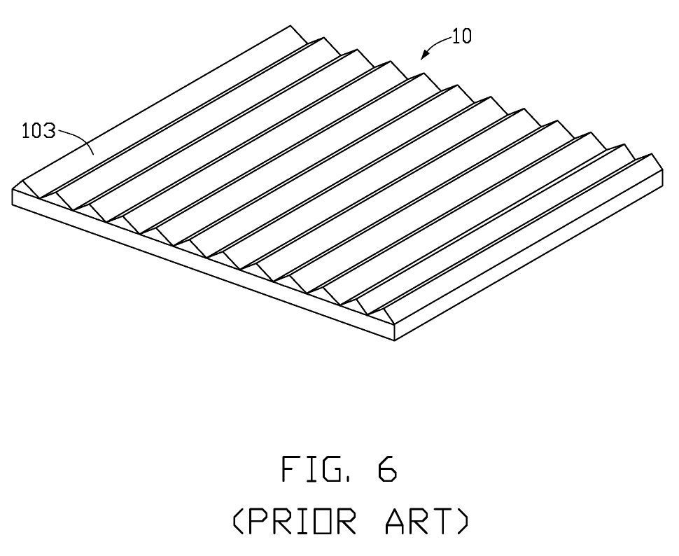

### DETAILED DESCRIPTION OF THE EMBODIMENTS

Reference will now be made to the drawings to describe preferred embodiments of the present prism sheet and liquid crystal display device, in detail.

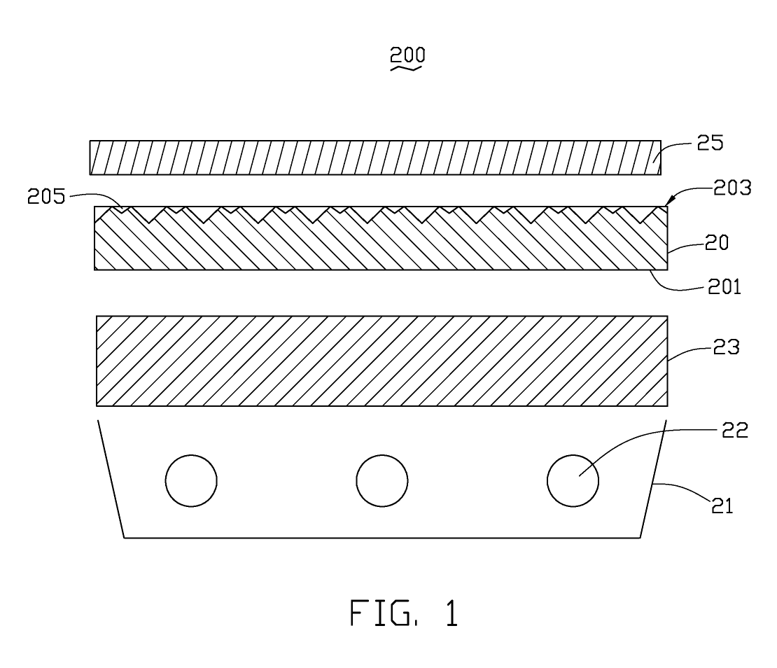

Referring to FIG. 1, a liquid crystal display device 200 according to a first embodiment of the present invention is shown. The liquid crystal display device 200 includes a housing 21, a plurality of light sources 22, a diffusion plate 23, a prism sheet 20, and a liquid crystal display panel 25. The light sources 22 are disposed in the housing 21. The diffusion plate 23, the prism sheet 20 and the liquid crystal display panel 25 are stacked on the housing 21 in that order. An interior of the housing 21 is configured for reflecting some of light upwards. The light diffusion plate 23 is configured for scattering light that enters the light diffusion plate 23.

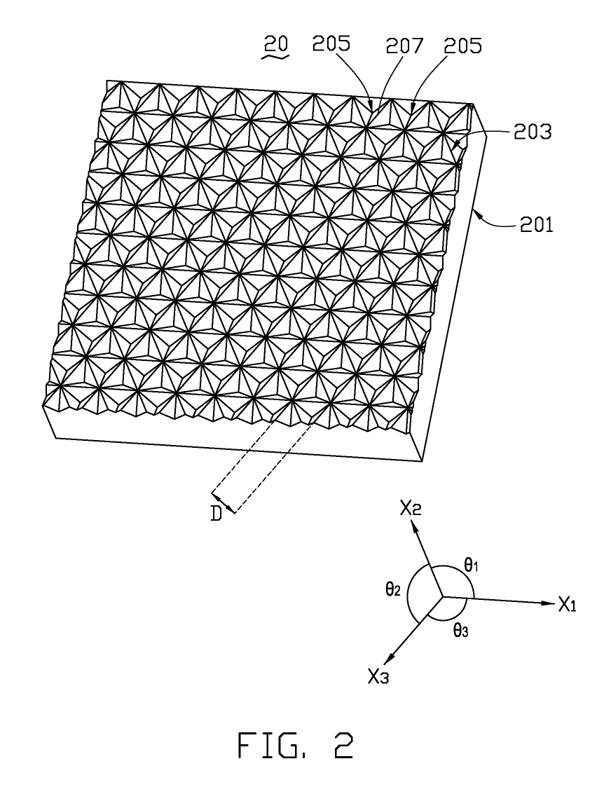

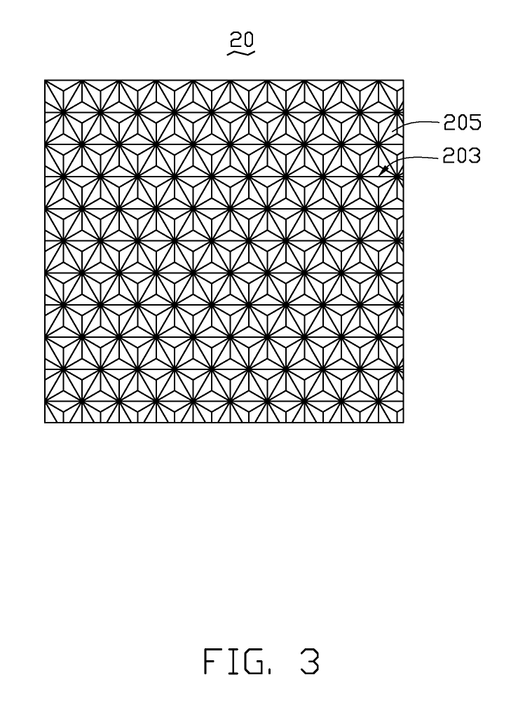

Referring to FIGS. 2 and 3, the prism sheet 20 includes a first surface 201 and a second surface 203. The first surface 201 and the second surface 203 are on opposite sides of the prism sheet 20. The prism sheet 20 is oriented such that the first surface 201 is adjacent to the light diffusion plate 23, and the second surface 203 is adjacent to the liquid crystal display panel 25. The light input surface 201 can be either smooth or rough. A plurality of triangular pyramidal optical elements 205 are formed at the light output surface 203. A bottom surface of each triangular pyramidal optical element 205 is coplanar with the light output surface 203. Each triangular pyramidal optical element 205 has three sides. Each one of the three sides of each triangular pyramidal optical element 205 is connected with a side of adjacent triangular pyramidal optical element 205 correspondingly.

In the first embodiment, the triangular pyramidal optical elements 205 are triangular pyramidal micro-depressions. Walls of the triangular pyramidal micro-depressions form a plurality of ridges 207. The ridges 207 mostly extend along one of three directions in a same plane, such as an X₁-direction, an X₂-direction and an X₃-direction. Angles θ₁, θ₂, and θ₃ defined by the X₁-X₂ directions, the X₂-X₃ directions, and the X₃-X₁ directions can be 120 degrees correspondingly. A distance D between center lines of adjacent ridges 207 along a same direction is in a range from 0.025 millimeters to 1 millimeter.

The prism sheet 20 can be integrally formed by injection molding technology. A thickness of the prism sheet 20 can be in a range from about 0.5 millimeters to 3 millimeters. The prism sheet 20 can be made of a material selected from the group consisting of polycarbonate, polymethyl methacrylate, polystyrene, copolymer of methyl methacrylate and styrene and any suitable combination thereof.

The housing 21 can be made of metal or plastic. The interior of the housing 21 is configured to be highly reflective.

The light sources 22 can be either point light sources such as light emitting diodes, or linear light sources such as cold cathode fluorescent lamps.

Light from the light sources 22 enters the diffusion plate 23 and becomes scattered. Scattered light then exits the diffusion sheet to the prism sheet 20. The scattered light is mostly condensed by the triangular pyramidal optical elements 205 when exiting the second surface 203 of the prism sheet 20. Thus a brightness of light illumination of the liquid crystal display device 200 can be enhanced. Furthermore, the bottom surface base of each triangular pyramidal optical element 205 is coplanar with the light output surface 203, each triangular pyramidal optical element 205 has three sides, and each one of the three sides of each triangular pyramidal optical element 205 is connected with a side of adjacent triangular pyramidal optical element 205. Therefore an arrangement of the triangular pyramidal optical elements 205 is different from that of pixels of the liquid crystal display panel 25. Thus moire pattern interference caused by the prism sheet 20 and the pixel pitch of the liquid crystal display panel 25 is kept minimal or eliminated.

In addition, in comparison to the conventional prism sheet, because the prism sheet 20 is integrally formed by injection molding, the prism sheet 20 is easier to mass-produce. Furthermore, because the prism lenses of the conventional prism sheet are formed by solidifying melted ultraviolet-cured transparent resin, the prism lenses of the conventional prism sheet are easily damaged and/or scratched due to poor rigidity and mechanical strength of the prism lenses. The prism sheet 20 of the present invention has better rigidity and mechanical strength than the conventional prism sheet. Therefore, the present prism sheet is not damaged or scratched.

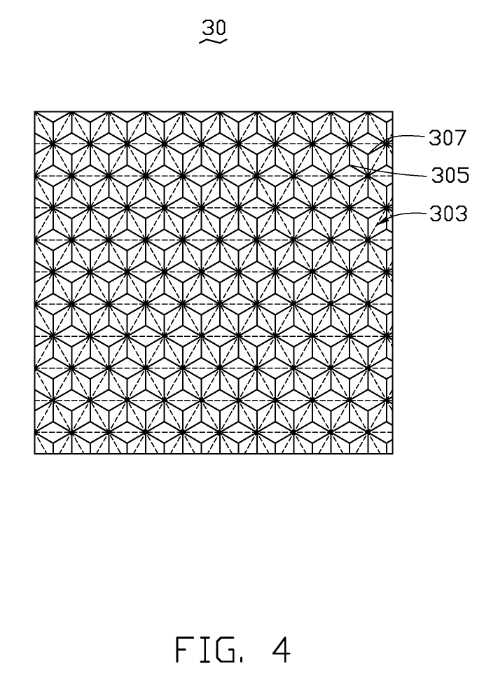

Referring to FIG. 4, a prism sheet 30 according to a second embodiment of the present invention is shown. The prism sheet 30 is similar in principle to the prism sheet 20. However a plurality of triangular pyramidal micro-depressions 305 and triangular pyramidal micro-protrusions 307 are formed in/at a light output surface 303. Each triangular pyramidal micro-depression 305 is surrounded by three triangular pyramidal micro-protrusions 307. A bottom surface base of each triangular pyramidal micro-depression 305 is coplanar with the bottom interface of each triangular pyramidal micro-protrusion 307.

It is noted that the scope of the present prism sheet and liquid crystal display is not limited to the embodiments described above. For example, in the prism sheet 30, the triangular pyramidal micro-depressions 305 can be omitted, and the three triangular pyramidal micro-protrusions 307 cover the whole light output surface 303.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A prism sheet, comprising:
a light input surface;
a light output surface opposite to the light input surface; and
a plurality of triangular pyramidal optical elements formed at the light output surface, wherein a bottom surface of each triangular pyramidal optical element is coplanar with the light output surface, each triangular pyramidal optical element having three sides, and each one of the three sides of each triangular pyramidal optical element is connected with a side of adjacent triangular pyramidal optical element.

2. The prism sheet as claimed in claim 1, wherein the triangular pyramidal optical elements are triangular pyramidal micro-depressions.

3. The prism sheet as claimed in claim 1, wherein the triangular pyramidal optical elements are triangular pyramidal micro-protrusions.

4. The prism sheet as claimed in claim 1, wherein the triangular pyramidal optical elements comprises triangular pyramidal micro-depressions and triangular pyramidal micro-protrusions, each triangular pyramidal micro-protrusion is surrounded by three triangular pyramidal micro-depressions.

5. The prism sheet as claimed in claim 1, wherein a thickness of the prism sheet is in a range from about 0.5 millimeters to about 3 millimeters.

6. The prism sheet as claimed in claim 1, wherein the prism sheet is made of material selected from the group consisting of polycarbonate, polymethyl methacrylate, polystyrene, copolymer of methyl methacrylate and styrene and any combination thereof.

7. A liquid crystal display device comprising:
a light source;
a light diffusion plate disposed above the light source;
a prism sheet disposed above the light diffusion plate, the prism sheet having:
a light input surface;
a light output surface opposite to the light input surface; and
a plurality of triangular pyramidal optical elements formed at the light output surface, wherein a bottom surface of each triangular pyramidal optical element is coplanar with the light output surface, each triangular pyramidal optical element having three sides, and each one of the three sides of each triangular pyramidal optical element is connected with a side of adjacent triangular pyramidal optical element; and
a liquid crystal display panel disposed above the prism sheet.

8. The liquid crystal display device as claimed in claim 7, wherein the light source is one of a point light source and a linear light source.

9. The liquid crystal display device as claimed in claim 7, wherein the liquid crystal display device further comprises a housing located under the light source, the housing is made of metal or plastic, and an interior of the housing is configured to be highly reflective.

10. The liquid crystal display device as claimed in claim 7, wherein the triangular pyramidal optical elements are triangular pyramidal micro-depressions.

11. The liquid crystal display device as claimed in claim 7, wherein the triangular pyramidal optical elements are triangular pyramidal micro-protrusions.

12. The liquid crystal display device as claimed in claim 7, wherein the triangular pyramidal optical elements comprises triangular pyramidal micro-depressions and triangular pyramidal micro-protrusions, each triangular pyramidal micro-protrusion is surrounded by three triangular pyramidal micro-depressions.

13. The liquid crystal display device as claimed in claim 7, wherein a thickness of the prism sheet is in a range from about 0.5 millimeters to about 3 millimeters.

14. The liquid crystal display device as claimed in claim 7, wherein the prism sheet is made of material selected from the group consisting of polycarbonate, polymethyl methacrylate, polystyrene, copolymer of methyl methacrylate and styrene and any combination thereof.
